(19) United States
(12) Patent Application Publication
(10) Pub. No.: US 2022/0010058 A1
(43) Pub. Date: Jan. 13, 2022

(54) LIQUID CRYSTAL POLYESTER RESIN COMPOSITION AND MOLDED ARTICLE

(71) Applicant: SUMITOMO CHEMICAL COMPANY, LIMITED, Tokyo (JP)

(72) Inventors: Tasuku TAMURA, Tsukuba-shi (JP); Tomoyuki HARA, Tokyo (JP)

(21) Appl. No.: 17/291,855

(22) PCT Filed: Nov. 7, 2019
(86) PCT No.: PCT/JP2019/043690

§ 371 Date: May 6, 2021

(30) Foreign Application Priority Data
Nov. 9, 2018 (JP) 2018-211192

(51) Int. Cl. C08G 63/60; C08J 5/04; C08K 7/10; C08K 7/08; C08K 7/06

(52) U.S. Cl. CPC C08G 63/605; C08J 5/042; C08K 7/10; C08K 7/08; C08K 2201/004; C08G 2250/00; C08J 2367/04; C08K 2201/014; C08K 7/06

(57) ABSTRACT

A liquid crystal polyester resin composition includes, as essential components: a component (A): liquid crystal polyester; a component (B): a glass fiber; and a component (C): a fibrous inorganic filling material different from the component (B), in which a blending amount of the component (B) with respect to 100 parts by mass of the component (A) is 50 parts by mass or more and 90 parts by mass or less, a blending amount of the component (C) with respect to 100 parts by mass of the component (A) is 1 part by mass or more and 40 parts by mass or less, and a condition (1) and a condition (2) are satisfied.

### TECHNICAL FIELD

The present invention relates to a liquid crystal polyester resin composition and a molded article.

### BACKGROUND ART

Liquid crystal polyester is known to be a material having high fluidity, heat resistance, and dimensional accuracy, and is used as a forming material for various molded articles. When molding a molded article, liquid crystal polyester is usually used as a liquid crystal polyester resin composition containing various filling materials. The filling material is selected according to required characteristics (for example, mechanical strength) of each molded article.

The molded article using the liquid crystal polyester as a forming material becomes smaller and thinner as an electronic device used as a part of an electronic device is miniaturized. For example, a part having a wall thickness of about 1.0 mm in the related art may be thinned to have a wall thickness of about 0.3 mm in response to a demand for miniaturization.

Such a thin-walled part is easily damaged. Therefore, when thinning a part, a part (molded article) with suppressed damage, in other words, a molded article having improved mechanical strength is required. In the related art, a liquid crystal polyester resin composition using a fibrous filling material as a filling material is known as a forming material for a molded article having improved mechanical strength (Patent Document 1).

In addition, for example, Patent Document 2 describes a thermoplastic resin composition containing a thermoplastic resin and agglomerated particles formed by aggregating fibrous crystals. Patent Document 2 describes a liquid crystal polymer as a thermoplastic resin.

### CITATION LIST

### Patent Document

### [Patent Document 1]

Japanese Unexamined Patent Application, First Publication No. H8-231832

### [Patent Document 2]

Japanese Unexamined Patent Application, First Publication No. 2010-215905

### SUMMARY OF INVENTION

### Technical Problem

When a part is thinned, particularly weld strength of a thin-walled portion tends to decrease. The thin-walled molded article obtained by using the resin composition of the related art described in Patent Document 1 had low weld strength, and there was room for improvement.

It is described that the thermoplastic resin composition described in Patent Document 2 was able to produce a molded article for the purpose of preventing the generation of welds when the molded article is molded, in which a weld line was not observed.

On the other hand, in a case where it is attempted to produce a molded article having a complicated shape or a thin-walled molded article, it may be difficult to completely prevent a weld from being generated. The technique described in Patent Document 2 has room for sufficient improvement from the viewpoint of improving weld strength.

An object of the present invention is to provide a liquid crystal polyester resin composition capable of producing a molded article having a higher weld strength in a thin wall compared to the related art.

### Solution to Problem

A liquid crystal polyester resin composition according to the present embodiment includes, as essential components: a component (A): liquid crystal polyester; a component (B): a glass fiber; and a component (C): a fibrous inorganic filling material different from the component (B), in which a blending amount of the component (B) with respect to 100 parts by mass of the component (A) is 50 parts by mass or more and 90 parts by mass or less, a blending amount of the component (C) with respect to 100 parts by mass of the component (A) is 1 part by mass or more and 40 parts by mass or less, and the following conditions (1) and (2) are satisfied.

Condition (1): melt viscosity measured at a predetermined measurement temperature within a temperature range of 20° C. to 30° C. higher than a flow start temperature range according to ISO 11443 under a condition of a shear rate of 1000 sec⁻¹ is 40 Pa·s or higher and 70 Pa·s or lower.

Condition (2): melt viscosity measured at the measurement temperature according to ISO 11443 under a condition of a shear rate of 12000 sec⁻¹ is 0.1 Pa·s or higher and 10 Pa·s or lower

The liquid crystal polyester resin composition according to the present embodiment is preferably a liquid crystal polyester resin composition in which a ratio ((1)/(2)) of the melt viscosity measured under the condition (1) to the melt viscosity measured under the condition (2) exceeds 5.0.

The liquid crystal polyester resin composition according to the present embodiment is preferably a liquid crystal polyester resin composition in which a number average fiber length of all fibrous filling materials in which the component (B) and the component (C) are combined is 40 μm or more and 80 μm or less.

In the present embodiment, it is preferable that the flow start temperature under the condition (1) is 320° C. or higher and 330° C. or lower and the measurement temperature is 350° C.

The liquid crystal polyester resin composition according to the present embodiment is preferably a liquid crystal polyester resin composition in which the component (C) is wollastonite.

A molded article according to the present embodiment is a molded article using the liquid crystal polyester resin composition described above as a forming material.

Furthermore, the present invention includes the following aspects.

A liquid crystal polyester resin composition according to the present embodiment includes, as essential components: a component (A): liquid crystal polyester; a component (B): a glass fiber; and a component (C): a fibrous inorganic filling material different from the component (B), in which a blending amount of the component (B) with respect to 100 parts by mass of the component (A) is 50 parts by mass or more and 90 parts by mass or less, a blending amount of the component (C) with respect to 100 parts by mass of the component (A) is 1 part by mass or more and 40 parts by mass or less, and the following conditions (1) and (2) are satisfied.

Condition (1): melt viscosity measured at a predetermined measurement temperature within a temperature range of 20° C. to 30° C. higher than a flow start temperature range according to ISO 11443 under a condition of a shear rate of 1000 s⁻¹ is 40 Pa·s or higher and 70 Pa·s or lower.

Condition (2): melt viscosity measured at the measurement temperature according to ISO 11443 under a condition of a shear rate of 12000 s⁻¹ is 0.1 Pa·s or higher and 10 Pa·s or lower

### Advantageous Effects of Invention

According to the present invention, it is possible to provide a liquid crystal polyester resin composition with which a molded article which is thinner than in the related art and has a high weld strength, and a molded article which is thinner than in the related art and has a high weld strength.

### BRIEF DESCRIPTION OF DRAWINGS

FIG. 1 is a schematic diagram representing a flow state of a resin in a case of applying the present invention.

FIG. 2 is a top view representing a molded article produced in Example.

FIG. 3 is a schematic diagram representing a test method for a weld strength test.

### DESCRIPTION OF EMBODIMENTS

<Liquid Crystal Polyester Resin Composition>

The liquid crystal polyester resin composition of the present embodiment contains a component (A), a component (B), and a component (C). Hereinafter, the “liquid crystal polyester resin composition” may be abbreviated as a “resin composition”.

Component (A): Liquid crystal polyester

Component (B): Glass fiber

Component (C): A fibrous inorganic filling material different from the component (B)

In the present embodiment, the “liquid crystal polyester resin composition” usually refers to a resin composition produced by melt-kneading the component (A), a raw material of the component (B), and a raw material of the component (C), and other components used as necessary. Examples of the liquid crystal polyester resin composition of the present embodiment include a pellet-shaped liquid crystal polyester resin composition.

Hereinafter, each component forming the liquid crystal polyester resin composition of the present embodiment will be described.

<<Liquid Crystal Polyester: Component (A)>>

The liquid crystal polyester contained in the liquid crystal polyester resin composition is a polyester that exhibits a liquid crystal property in a molten state, and preferably has a property of melting at a temperature of 450° C. or lower. The liquid crystal polyester may be a liquid crystal polyester amide, a liquid crystal polyester ether, a liquid crystal polyester carbonate, or a liquid crystal polyester imide. The liquid crystal polyester is preferably a total aromatic liquid crystal polyester using only an aromatic compound as a raw material monomer.

Typical examples of the liquid crystal polyesters include the followings.

1) A polymer obtained by polymerizing (polycondensation) (i) an aromatic hydroxycarboxylic acid, (ii) an aromatic dicarboxylic acid, and (iii) at least one compound selected from the group consisting of an aromatic diol, aromatic hydroxylamine, and an aromatic diamine.

2) A polymer obtained by polymerizing a plurality of kinds of aromatic hydroxycarboxylic acids.

3) A polymer obtained by polymerizing (i) an aromatic dicarboxylic acid and (ii) at least one compound selected from the group consisting of an aromatic diol, aromatic hydroxylamine, and an aromatic diamine.

4) A polymer obtained by polymerizing (i) a polyester such as polyethylene terephthalate and (ii) an aromatic hydroxycarboxylic acid.

Here, regarding the aromatic hydroxycarboxylic acid, the aromatic dicarboxylic acid, the aromatic diol, the aromatic hydroxylamine, and the aromatic diamine, which are raw material monomers of the liquid crystal polyester, polymerizable derivatives thereof may each independently be used instead of a part or all of the raw material monomers.

Examples of the polymerizable derivatives of a compound having a carboxy group, such as an aromatic hydroxycarboxylic acid and an aromatic dicarboxylic acid include

(a) an ester obtained by converting a carboxy group into an alkoxycarbonyl group or an aryloxycarbonyl group,

(b) an acid halide obtained by converting a carboxy group into a haloformyl group, and

(c) an acid anhydride obtained by converting a carboxy group into an acyloxycarbonyl group.

Examples of the polymerizable derivatives of the compound having a hydroxy group, such as an aromatic hydroxycarboxylic acid, an aromatic diol, and aromatic hydroxylamine, include an acylated product obtained by acylating a hydroxy group to be converted into an acyloxyl group.

Examples of polymerizable derivatives of the compound having an amino group, such as aromatic hydroxylamine and an aromatic diamine, include an acylated product obtained by acylating an amino group to be converted into an acylamino group.

The liquid crystal polyester preferably has a repeating unit represented by the following formula (1), and more preferably has a repeating unit (1), a repeating unit represented by the following formula (2), and a repeating unit represented by the following formula (3).

Hereinafter, the repeating unit represented by the following formula (1) may be referred to as a “repeating unit (1)”.

Further, the repeating unit represented by the following formula (2) may be referred to as a “repeating unit (2)”.

Further, the repeating unit represented by the following formula (3) may be referred to as a “repeating unit (3)”.

—O—Ar¹—CO— (1)

—CO—Ar²—CO— (2)

—X—Ar³—Y— (3)

(Ar¹ represents a phenylene group, a naphthylene group, or a biphenylylene group.

Ar² and Ar³ each independently represent a phenylene group, a naphthylene group, a biphenylylene group, or a group represented by the following formula (4).

X and Y each independently represent an oxygen atom or an imino group (—NH—).

Hydrogen atoms in the group represented by Ar¹, Ar² or Ar³ may be each independently substituted with a halogen atom, an alkyl group, or an aryl group.)

—Ar⁴—Z—Ar⁵— (4)

(Ar⁴ and Ar⁵ each independently represent a phenylene group or a naphthylene group.

Z represents an oxygen atom, a sulfur atom, a carbonyl group, a sulfonyl group, or an alkylidene group.)

Examples of a halogen atom capable of substituting the hydrogen atom contained in the group represented by Ar¹, Ar², or Ar³ include a fluorine atom, a chlorine atom, a bromine atom, and an iodine atom.

Examples of an alkyl group capable of substituting a hydrogen atom contained in the group represented by Ar¹, Ar², or Ar³ include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group. The alkyl group usually has 1 to 10 carbon atoms.

Examples of an aryl group capable of substituting a hydrogen atom contained in the group represented by Ar¹, Ar², or Ar³ include a phenyl group, an o-tolyl group, an m-tolyl group, a p-tolyl group, 1-naphthyl group, and a 2-naphthyl group. The aryl group usually has 6 to 20 carbon atoms.

In a case where a hydrogen atom contained in the group represented by Ar¹, Ar², or Ar³ is substituted with a halogen atom, an alkyl group, or an aryl group, the number of the halogen atoms, the alkyl groups, or the aryl groups is usually 2 or less and preferably 1 or less each independently for each group represented by Ar¹, Ar², or Ar³.

Examples of the alkylidene group represented by Z include a methylene group, an ethylidene group, an isopropylidene group, an n-butylidene group, and a 2-ethylhexylidene group. The alkylidene group usually has 1 to 10 carbon atoms.

The repeating unit (1) is a repeating unit derived from an aromatic hydroxycarboxylic acid.

As the repeating unit (1), a repeating unit in which Ar¹ is a p-phenylene group is preferable.

The repeating unit in which Ar¹ is the p-phenylene group is a repeating unit derived from a p-hydroxybenzoic acid.

Another example of the repeating unit (1) include a repeating unit in which Ar¹ is a 2,6-naphthylene group. The repeating unit in which Ar¹ is a 2,6-naphthylene group is a repeating unit derived from a 6-hydroxy-2-naphthoic acid.

In the present specification, the term “derived” refers to that a chemical structure of a functional group that contributes to the polymerization changes due to the polymerization of a raw material monomer, and no other structural change occurs.

The repeating unit (2) is a repeating unit derived from an aromatic dicarboxylic acid. As the repeating unit (2), a repeating unit in which Ar² is a p-phenylene group, a repeating unit in which Ar² is an m-phenylene group, a repeating unit in which Ar² is a 2,6-naphthylene group, and a repeating unit in which Ar² is a diphenylether-4,4′-diyl group are preferable.

The repeating unit in which Ar² is the p-phenylene group is a repeating unit derived from a terephthalic acid.

The repeating unit in which Ar² is the m-phenylene group is a repeating unit derived from an isophthalic acid.

The repeating unit in which Ar² is the 2,6-naphthylene group is a repeating unit derived from a 2,6-naphthalene dicarboxylic acid.

The repeating unit in which Ar² is the diphenylether-4,4′-diyl group is a repeating unit derived from a diphenylether-4,4′-dicarboxylic acid.

The repeating unit (3) is a repeating unit derived from an aromatic diol, an aromatic hydroxylamine, or an aromatic diamine. As the repeating unit (3), a repeating unit in which Ar³ is a p-phenylene group and a repeating unit in which Ar³ is a 4,4′-biphenylene group are preferable.

The repeating unit in which Ar³ is the p-phenylene group is a repeating unit derived from hydroquinone, p-aminophenol, or p-phenylenediamine.

The repeating unit in which Ar³ is the 4,4′-biphenylylene group is a repeating unit derived from 4,4′-dihydroxybiphenyl, 4-amino-4′-hydroxybiphenyl, or 4,4′-diaminobiphenyl.

A content of the repeating unit (1) is usually 30 mol % or more, preferably 30 to 80 mol %, more preferably 40 to 70 mol %, and still more preferably 45 to 65 mol %, with respect to a total amount of all repeating units.

In the present specification, the “total amount of all repeating units” indicates a value obtained in a manner that the mass of each repeating unit configuring the liquid crystal polyester is divided by a formula amount of each repeating unit to obtain a substance equivalent of each repeating unit (mol) and then the obtained substance equivalents are totalled.

The content of the repeating unit (2) is usually 35 mol % or less, preferably 10 mol % or more and 35 mol %, more preferably 15 mol % or more and 30 mol % or less, still more preferably 17.5 mol % or more and 27.5 mol % or less, with respect to the total amount of all repeating units.

The content of the repeating unit (3) is usually 35 mol % or less, preferably 10 mol % or more and 35 mol %, more preferably 15 mol % or more and 30 mol % or less, still more preferably 17.5 mol % or more and 27.5 mol % or less, with respect to the total amount of all repeating units.

As the content of the repeating unit (1) is higher, it is easier to improve a melt fluidity, a heat resistance, or a strength or rigidity. However, if the content is too high, a melt temperature or melt viscosity tends to increase, and a temperature required for molding tends to increases.

A ratio of the content of the repeating unit (2) to the content of the repeating unit (3) is expressed by [Content of repeating unit (2)]/[Content of repeating unit (3)](mol/mol) and is usually 0.9/1 to 1/0.9, preferably 0.95/1 to 1/0.95, and more preferably 0.98/1 to 1/0.98.

The liquid crystal polyester may each independently have two or more repeating units (1) to (3). In addition, the liquid crystal polyester may have a repeating unit other than the repeating units (1) to (3), and a content thereof is usually 10 mol % or less and preferably 5 mol % or less, with respect to the total amount of all repeating units.

The liquid crystal polyester preferably has, as the repeating unit (3), a repeating unit in which X and Y each are an oxygen atom, that is, a repeating unit derived from an aromatic diol, and more preferably only has a repeating unit in which X and Y each are an oxygen atom.

It is preferable that the liquid crystal polyester has the repeating unit derived from an aromatic diol in that the melt viscosity of the liquid crystal polyester tends to be lowered.

The liquid crystal polyester has a flow start temperature of usually 270° C. or higher, preferably 270° C. or higher and 400° C. or lower, more preferably 280° C. or higher and 380° C. or lower, particularly preferably 290° C. or higher and 350° C. or lower, and specially 320° C. or higher and 330° C. or lower. As the flow start temperature is higher, it is easier for the strength to improve.

The flow start temperature is also referred to as a flow temperature or a temperature for flowing. The flow start temperature of the liquid crystal polyester is a temperature at which a viscosity of 4800 Pa·s (48000 poise) is shown when the liquid crystal polyester is melted and extruded from a nozzle having an inner diameter of 1 mm and a length of 10 mm by using a rheometer while raising a temperature at a rate of 4° C./min under a load of 9.8 MPa. The flow start temperature of the liquid crystal polyester is a measure of a molecular weight of the liquid crystal polyester (see “Liquid Crystal Polymer, -Synthesis Molding Application-”, edited by Naoyuki Koide, CMC Co., Ltd., Jun. 5, 1987, p. 95).

The liquid crystal polyester used in the present embodiment can be produced by a known polycondensation method, ring-opening polymerization method, or the like. The liquid crystal polyester used in the present embodiment can be produced by melt-polymerizing a raw material monomer corresponding to a constituent repeating unit and a solid-phase polymerizing the obtained polymer. As a result, a liquid crystal polyester having a high-strength and a high molecular weight can be produced with good operability.

The melt polymerization may be carried out in the presence of a catalyst. Examples of the catalyst include a metal compound such as magnesium acetate, stannous acetate, tetrabutyl titanate, lead acetate, sodium acetate, potassium acetate, and antimony trioxide, a nitrogen-containing heterocyclic compound such as 4-(dimethylamino)pyridine and 1-methylimidazole, or the like. Among these, the nitrogen-containing heterocyclic compound is preferably used.

<<Glass Fiber: Component (B)>>

The resin composition of the present embodiment contains the component (B). The component (B) is a glass fiber. The component (B) can be present in the resin composition by melt-kneading the raw material of the component (B) and other components. It is known that the raw material of the component (B) breaks during such melt-kneading.

In other words, the raw material of the component (B) is a component used for melt-kneading. A fiber diameter of the raw material of the component (B) does not substantially change before and after the melt-kneading. Hereinafter, the raw material of the component (B) will be described.

Examples of the raw material of the component (B) include a long fiber type chopped glass fiber and a short fiber type milled glass fiber. A method for producing the raw material of the component (B) is not particularly limited, and a known method can be used. In the present embodiment, the raw material of the component (B) is preferably the chopped glass fiber. The raw material of the component (B) may be used alone, or two or more kinds thereof may be used in combination.

Examples of the kinds of the raw material of the component (B) include E-glass, A-glass, C-glass, D-glass, AR-glass, R-glass, S glass, or a mixture thereof. Among these, the E-glass is preferably used in terms of an excellent strength and availability.

The raw material of the component (B) may be a glass fiber having a silicon oxide content of 50% by mass or more and 80% by mass or less, or 52% by mass or more and 60% by mass or less, with respect to the total mass of the raw material of the component (B).

The raw material of the component (B) may be glass fiber treated, as necessary, with a coupling agent such as a silane-based coupling agent or a titanium-based coupling agent.

The raw material of the component (B) may be a glass fiber treated with a sizing agent. Examples of the sizing agent include a thermoplastic resin such as a urethane resin, an acrylic resin, and an ethylene-vinyl acetate copolymer, and a thermosetting resin such as an epoxy resin.

The number average fiber length of the raw material of the component (B) is preferably 20 μm or more and 6000 μm or less. The number average fiber length of the raw material of the component (B) is more preferably 1000 μm or more, and still more preferably 2000 μm or more. The number average fiber length of the raw material of the component (B) is more preferably 5000 μm or less, and still more preferably 4500 μm or less.

The upper limit values and the lower limit values can be randomly combined. Examples of the combination include 1000 μm or more and 5000 μm or less, and 2000 μm or more and 4500 μm or less.

In a case where the number average fiber length of the raw material of the component (B) is equal to or more than the above lower limit value, the obtained molded article can be sufficiently reinforced. In addition, when the number average fiber length of the component (B) is equal to or less than the above upper limit value, the raw material of the component (B) can be easily handled at the time of production.

The single fiber diameter of the raw material of the component (B) is preferably 5 μm or more and 17 μm or less. In a case where the single fiber diameter of the raw material of the component (B) is 5 μm or more, the obtained molded article can be sufficiently reinforced. In addition, in a case where the fiber diameter of the raw material of the component (B) is 17 μm or less, the melt fluidity of the liquid crystal polyester resin composition can be increased. Here, the “single fiber diameter” refers to a fiber diameter of a single fiber of the raw material of the component (B).

((B) Method for Measuring Number Average Fiber Length and Single Fiber Diameter of Raw Material of the Component (B))

In the present specification, the “number average fiber length of the raw material of the component (B)” refers to a value measured by the method described in JIS R3420 “7.8 Chopped Strand Length” unless otherwise specified.

Further, in the present specification, the “single fiber diameter of the raw material of the component (B)” refers to a value measured by an “A method” among the methods described in JIS R3420 “7.6 single fiber diameter” unless otherwise specified.

In the present embodiment, a blending amount of the component (B) with respect to 100 parts by mass of the component (A) is 50 parts by mass or more and 90 parts by mass or less, and preferably 70 parts by mass or more and 90 parts by mass or less. In the present embodiment, even in a case where the blending amount of the component (B) is within the above range and an ultra-thin molded article is produced, a decrease in the strength of a welded portion as compared with a non-welded portion can be suppressed. In the present embodiment, when increasing the blending amount of the component (B), it is possible to increase the strength of the non-welded portion.

Here, the ultra-thin refers to a wall thickness of 0.5 mm or less and preferably 0.3 mm or less.

<<Fibrous Inorganic Filling Material Different from Component (B): Component (C)>>

The component (C) is a fibrous filler different from the component (B). The component (C) can be present in the resin composition by melt-kneading the raw material of the component (C) and other components. It is known that the raw material of the component (C) is deformed during such melt-kneading. An example of the deformation is breakage. In other words, the raw material of the component (C) is a component used for melt-kneading. A fiber diameter of the raw material of the component (C) does not substantially change before and after the melt-kneading. Hereinafter, the raw material of the component (C) will be described.

The raw material of the component (C) is preferably a fibrous inorganic filling material having a number average fiber length different from that of the raw material of the component (B). It is preferable that a difference in number average fiber length between the raw material of the component (B) and the raw material of the component (C) is 5 μm or more.

In the present embodiment, the raw material of the component (B) may have a longer number average fiber length than that of the raw material of the component (C), and the raw material of the component (C) may have a number average fiber length longer than that of the raw material of the component (B).

The raw material of the component (C) used in the present embodiment is preferably a fibrous inorganic filling material having a shorter number average fiber length than that of the raw material of the component (B).

In the present embodiment, examples of the raw material of the component (C) include a carbon fiber, a silica fiber, an alumina fiber, a ceramic fiber such as a silica-alumina fiber, a metal fiber such as a stainless steel fiber, and a whisker. Among these, the carbon fiber or the whisker is preferable.

Examples of commercially available carbon fiber products include “TORAYCA (registered trademark)” manufactured by Toray Co., Ltd., “Pyrofil (registered trademark)” and “DIALEAD (registered trademark) which are manufactured by Mitsubishi Chemical Co., Ltd., “Tenax (registered trademark)” manufactured by Teijin Co., Ltd., “GRANOC (registered trademark)” manufactured by Nippon Graphite Fiber Co., Ltd., “DONACARBO (registered trademark)” manufactured by Osaka Gas Chemical Co., Ltd., and KRECA (registered trademark)” manufactured by Kureha Corporation.

Examples of the whisker include a potassium titanate whisker, a barium titanate whisker, an aluminum borate whisker, a silicon nitride whisker, and a calcium silicate whisker.

Examples of the calcium silicate whisker include wollastonite, zonotrite, tovamorite, and gyrolite.

In the present embodiment, the raw material of the component (C) is preferably the wollastonite, the potassium titanate whisker, or the aluminum borate whisker, and among these, the wollastonite is more preferable from the viewpoint of availability or economy.

Examples of commercially available potassium titanate whisker include “Tismo D” and “Tismo N” manufactured by Otsuka Chemical Co., Ltd.

Examples of commercially available aluminum borate whisker include “Albolex G” and “Albolex Y” manufactured by Shikoku Chemicals Corporation.

The wollastonite used in the present embodiment may be a fibrous wollastonite or a granular wollastonite. The fibrous wollastonite is wollastonite having an aspect ratio of 3 or more. The granular wollastonite is wollastonite having an aspect ratio of less than 3. Here, the aspect ratio indicates “Number average fiber length of raw material of the component (C)/Number average fiber diameter of raw material of the component (C)”.

In the present embodiment, the fibrous wollastonite is preferable, and the aspect ratio is more preferably 3 or more and 20 or less, still more preferably 5 or more and 15 or less, and particularly preferably 10 or more and 13 or less. When fibrous wollastonite having an aspect ratio in such a range is used, the weld strength of the thin-walled molded article is enhanced.

The wollastonite is not particularly limited, and for example, a known wollastonite can be used. The wallastonite may be used alone or two or more wollastonite each having different aspect ratios, number average fiber lengths of the raw material of the component (C), and the number average fiber diameter of the raw material of the component (C) may be used in combination.

The number average fiber length of the raw material of the component (C) is preferably 1 μm or more, more preferably 3 μm or more, particularly preferably 5 μm or more, and especially preferably 10 μm or more. In addition, this number average fiber length is preferably 10000 μm or less, more preferably 500 μm or less, still more preferably 300 μm or less, still further preferably 150 μm or less, and especially preferably 60 μm or less.

The upper limit values and the lower limit values can be randomly combined.

Examples of the combination include 1 μm or more and 10000 μm or less, 3 μm or more and 500 μm or less, 5 μm or more and 300 μm or less, 10 μm or more and 150 μm or less, and 10 μm or more and 60 μm or less.

The number average fiber diameter of the raw material of the component (C) is preferably 0.4 μm or more, more preferably 0.7 μm or more, still more preferably 1 μm or more, still further preferably 3 μm or more, and especially preferably 4 μm or more. In addition, this number average fiber diameter is preferably 50 μm or less, more preferably 10 μm or less, still more preferably 8 μm or less, and especially preferably 5 μm or less.

The upper limit values and the lower limit values can be randomly combined.

Examples of the combination include 0.4 μm or more and 50 μm or less, 0.4 μm or more and 10 μm or less, 0.4 μm or more and 8 μm or less, and 0.7 μm or more and 8 μm or less.

Method for Measuring Number Average Fiber Length and Number Average Fiber Diameter of Raw Material of the Component (C)

The number average fiber length and the number average fiber diameter of the raw material of the component (C) are obtained by observing 100 fibers for the length and diameter of the raw material of the component (C) using a microscope and calculating an average value.

In the present embodiment, a blending amount of the component (C) with respect to 100 parts by mass of the component (A) is 1 part by mass or more and 40 parts by mass or less. When the blending amount of the component (C) is within the above range, the weld strength can be enhanced even in a case where an ultra-thin molded article is produced. The blending amount of the component (C) is preferably 5 parts by mass or more and 40 parts by mass or less.

In the present embodiment, regarding the number average fiber length of all fibrous filling materials in which the component (B) and the component (C) are combined, the number average fiber length is preferably 40 μm or more and 80 μm or less, more preferably 45 μm or more and 79 μm or more, and particularly preferably 48 μm or more and 78 μm or less.

Here, “the number average fiber length of all fibrous filling materials in which the component (B) and the component (C) are combined” refers to a number average fiber length of all fibrous filling material contained in the liquid crystal polyester resin composition after melt kneading or a molded article obtained by molding the liquid crystal polyester resin composition.

When the number average fiber length of all fibrous filling materials in which the component (B) and the component (C) are combined is in the above range, a mechanical strength can be maintained even when an ultra-thin molded article is manufactured.

(Method for Measuring Number Average Fiber Length of all Fibrous Filling Materials)

A method for measuring the all fibrous filling materials will be described.

First, 5 g of the liquid crystal polyester resin composition of the present embodiment is heated in a muffle furnace (manufactured by Yamato Scientific Co., Ltd., “FP410”) at 600° C. for 4 hours in an air atmosphere to remove a resin to obtain an ashing residue containing a fibrous filling material.

0.3 g of the ashing residue is added to 50 mL of pure water, and a surfactant (for example, 0.5% by volume micro-90 (manufactured by Sigma-Aldrich Japan GK) aqueous solution) is added to improve a dispersibility to obtain a liquid mixture.

The obtained liquid mixture is ultrasonically dispersed for 5 minutes to obtain a sample solution in which the fibrous filling material contained in the ashing residue is uniformly dispersed in a solution. For ultrasonic dispersion, device name: ULTRA SONIC CLEANER NS200-60 (manufactured by Nissei Tokyo Office Co., Ltd.) or the like can be used. An ultrasonic intensity may be, for example, 30 kHz.

Next, 5 mL of the obtained sample solution is collected, placed in a sample cup, and diluted 5-fold with pure water to obtain a sample liquid. Using a particle shape image analyzer (“PITA-3” manufactured by Seishin Enterprise Co., Ltd.) under the following conditions, the obtained sample liquid is passed through a flow cell, and fibrous filling materials that move in the liquid imaged one by one. In this measurement method, the time when the number of all fibrous filling materials accumulated from the start of measurement reaches 30000 is defined as the end of measurement.

[Conditions]

Number of measurements: 30000

Dispersion solvent: Water

Dispersion conditions: 0.5% by volume aqueous solution of micro-90 is used as

a carrier liquid 1 and a carrier liquid 2.

Sample liquid speed: 4.17 μL/sec

Carrier liquid 1 speed: 500 μL/sec

Carrier liquid 2 speed: 500.33 μL/sec

Observation magnification: Objective 10 times

Dimming filter: Diffusion PL

An obtained image is binarized, the circumscribing rectangular major axes of the fibrous filling material in the processed image are measured, and an average value of values of 30000 circumscribing rectangular major axes is calculated as the number average fiber length of all fibrous filling materials.

<<Optional Component>>

In the liquid crystal polyester resin composition of the present embodiment, an additive such as a measurement stabilizer, a mold release agent, an antioxidant, a heat stabilizer, an ultraviolet absorber, an antistatic agent, a surfactant, a flame retardant, and a colorant may be contained as an optional component.

In the liquid crystal polyester resin composition of the present embodiment, the component (A), the raw material of the component (B), the raw material of the component (C), and other components used as necessary can be melt-kneaded by using an extruder to be pelletized.

The liquid crystal polyester resin composition of the present embodiment satisfies the following conditions (1) and (2).

Condition (1): melt viscosity measured at a predetermined measurement temperature within a temperature range of 20° C. to 30° C. higher than a flow start temperature range according to ISO 11443 under a condition of a shear rate of 1000 s⁻¹ is 40 Pa·s or higher and 70 Pa·s or lower, preferably 45 Pa·s or higher and 70 Pa·s or lower, more preferably 50 Pa·s or higher and 70 Pa·s or lower, and particularly preferably 60 Pa·s or higher and 70 Pa·s or lower.

Condition (2): melt viscosity measured at the measurement temperature according to ISO 11443 under a condition of a shear rate of 12000 s⁻¹ is 0.1 Pa·s or higher and 10 Pa·s or lower, preferably 1 Pa·s or higher and 10 Pa·s or lower, more preferably 5 Pa's or higher and 10 Pa's or lower, and particularly preferably 7 Pa's or higher and 10 Pa's or lower.

In the liquid crystal polyester resin composition of the present embodiment can be obtained as a composition with increased dependence of melt viscosity on shear rate by appropriately selecting and using kinds and the amount of a liquid crystal polyester (A), a glass fiber (B), and a fibrous inorganic filler (C) different from the component (B).

In the present embodiment, it is preferable that the flow start temperature is 320° C. or higher and 330° C. or lower and the measurement temperature is 350° C. When measuring the melt viscosity, it is preferable that the resin composition of the present embodiment is dried at 120° C. for 3 hours or more and then measured.

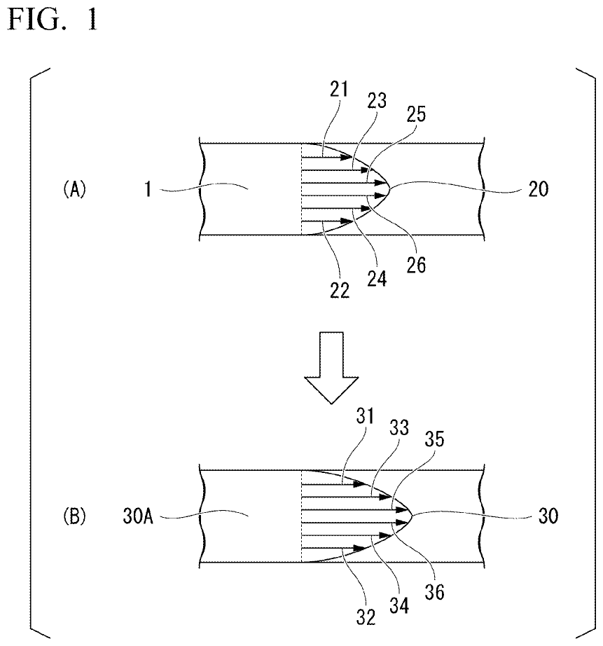

FIG. 1(A) shows a schematic diagram of a tip of a molten resin 1 obtained by melting a resin composition of the related art. The arrows shown by reference numerals 21 to 26 indicate the molten resins. The length of each arrow indicates the flow velocity of the molten resin. The molten resin 21 and the molten resin 22 on an inner wall side of a mold are slower than the molten resin 23 and the molten resin 24 flowing an inside of the mold, and the molten resin 25 and the molten resin 26 flowing at the position corresponding to the tip 20 are the fastest. Due to such a difference in the flow velocity of the molten resin, the tip 20 of the molten resin has a convex shape.

FIG. 1(B) shows a schematic diagram of the tip of a molten resin 30A obtained by melting the resin composition of the present embodiment. The arrows shown by reference numerals 31 to 36 indicate the molten resins. It is considered that since the resin composition of the present embodiment has increased dependence of melt viscosity on the shear rate, the difference in the flow velocity of the molten resin between the inner wall side of the mold and the inside of the mold is larger than that of the resin composition of the related art of FIG. 1 (A) and a convex shape of the tip of the molten resin is sharper.

Then, when the sharper convex tips collide with each other, it is predicted that the tips of the molten resin enter each other and the interface is disturbed. When the interface is disturbed, the contact area between the tips of the molten resin increases. As a result, it is considered that the weld strength improves.

In the present embodiment, a ratio ((1)/(2)) of the melt viscosity measured under the condition (1) to the melt viscosity measured under the condition (2) preferably exceeds 5.0, and is more preferably 5.1 or more, and still more preferably 5.2 or more. An upper limit value is usually 50, preferably 20, more preferably 18, and especially preferably 17. It is considered that when the ratio of the melt viscosity is within the range, the difference in flow velocity between the molten resin flowing near the inner wall side of the mold and the molten resin flowing near the inside of the mold can be increased.

The upper limit value and the lower limit value of the ratio ((1)/(2)) can be randomly combined. Examples of combinations include more than 5.0 and 50 or less, 5.1 or more and 20 or less, and 5.2 or more and 18 or less.

<Molded Article>

The molded article of the present embodiment is usually an injection-molded article used as a housing interior part or the like in an electric/electronic device. Examples of the electric/electronic device include cameras, personal computers, mobile phones, smartphones, tablets, printers, and projectors. Examples of housing interior parts in such electric/electronic devices include connectors, camera modules, blower fans, and fixing parts for printers.

The molded article of the present embodiment is preferably a molded article having an ultra-thin portion having a thickness of 0.3 mm or less. The thickness of the molded article refers to a thickness from one side to the other side of the molded article.

### Examples

Hereinafter, the present invention will be further specifically described using Examples. An analysis and evaluation for a property of the liquid crystal polyester were performed by a method described below.

<Component (A): Production of Liquid Crystal Polyester (LCP)>

994.5 g (7.2 mol) of 4-hydroxybenzoic acid, 272.1 g (1.64 mol) of terephthalic acid, 126.6 g (0.76 mol) of isophthalic acid, 446.9 g (2.4 mol) of 4,4′-dihydroxybiphenyl, and 1347.6 g (13.2 mol) of acetic anhydride were charged in a reactor including a stirrer, a torque meter, a nitrogen gas introduction tube, a thermometer and a reflux condenser, and 0.2 g of 1-methylimidazole was added thereto as a catalyst, and the inside of the reactor was sufficiently substituted with a nitrogen gas.

Then, the temperature was raised from a room temperature to 150° C. over 30 minutes while stirring under a nitrogen gas stream, and the temperature was maintained at the same temperature and refluxed for 30 minutes.

Then, 2.4 g of 1-methylimidazole was added, and the temperature was raised from 150° C. to 320° C. over 2 hours and 50 minutes while distilling off the by-product acetic acid and unreacted acetic anhydride, and kept at 320° C. for 30 minutes. Thereafter, the contents were taken out and cooled to a room temperature.

The obtained solid matter is pulverized with a pulverizer to a particle size of 0.1 mm or more and 1 mm or less, then heated from a room temperature to 250° C. over 1 hour under a nitrogen atmosphere, and then a temperature thereof was raised from 250° C. to 295° C. over 5 hours, and kept at 295° C. for 3 hours to carry out a solid phase polymerization. After the solid phase polymerization, it was cooled to obtain a powdery liquid crystal polyester (LCP). The flow start temperature of the obtained liquid crystal polyester was 312° C.

<Component (B): Glass Fiber>

As the raw material of the component (B), chopped glass fiber (CS 3J-260S (single fiber diameter 11 μm, number average fiber length 3 mm)) manufactured by Nitto Boseki Co., Ltd. was used.

<Component (C): Fibrous Inorganic Filling Material>

As the raw material of the component (C), wollastonite (NYGLOS 4W (number average fiber length 50 μm, number average fiber diameter 4.5 μm)) manufactured by NYCO Minerals was used. A case where the “component (C)” is described in Tables 1 to 3 indicates that wollastonite (NYGLOS 4W (number average fiber length 50 μm, number average fiber diameter 4.5 μm)) manufactured by NYCO Minerals was used.

In Table 4, “(C)-1” indicates that as the component (C), potassium titanate whiskers (product name: Tismo D, manufactured by Otsuka Chemical Co., Ltd., number average fiber length 15 μm, number average fiber diameter 0.45 μm) was used.

In Table 4, “(C)-2” indicates that as the component (C), carbon fiber (product name: TR06NL, manufactured by Mitsubishi Chemical Corporation, number average fiber length 6 mm, number average fiber diameter 7.0 μm) was used.

In Table 4, “(C)-3” indicates that as the component (C), an aluminum borate whisker (product name: Alporex Y, manufactured by Shikoku Kasei Kogyo Co., Ltd., number average fiber length 20 μm, number average fiber diameter 0.75 μm) was used.

The above component (A), the raw material of the component (B), and the raw material of the component (C) were mixed in advance using a Henschel mixer at the ratios shown in Tables 1 to 4, and then melt-kneaded at 330° C. using an isodirectional twin-screw extruder (PCM-30) manufactured by Ikegai Corp. to obtain a pellet-shaped liquid crystal polyester resin composition. The mixture mixed at the ratio of Comparative Example 18 could not be granulated into a pellet shape.

<Method for Measuring Flow Start Temperature of Liquid Crystal Polyester Resin Composition>

Using a flow tester (Shimadzu Seisakusho Co., Ltd. “CFT-500 type”), a cylinder with a die having a nozzle with an inner diameter of 1 mm and a length of 10 mm was filled with about 2 g of liquid crystal polyester resin composition pellets after drying at 120° C. for 3 hours. The liquid crystal polyester was melted and extruded from a nozzle while raising the temperature at a rate of 4° C./min under a load of 9.8 MPa, and the temperature at which a viscosity indicates 4800 Pa·s (48000 poise) was measured.

<Measurement of Melt Viscosity>

A capillary rheometer (“Capillary Graph 1D” manufactured by Toyo Seiki Co., Ltd.) was used to measure the melt viscosity of the liquid crystal polyester resin composition. The capillary used was 1.0 mmΦ×10 mm. 20 g of a pellet-shaped liquid crystal polyester resin composition dried at 120° C. for 3 hours was placed in a cylinder set at 350° C., and the melt viscosities were measured at shear rates of 1000 s⁻¹ and 12000 s⁻¹ according to ISO 11443.

<Measurement of Weld Bending Strength>

Test Pieces

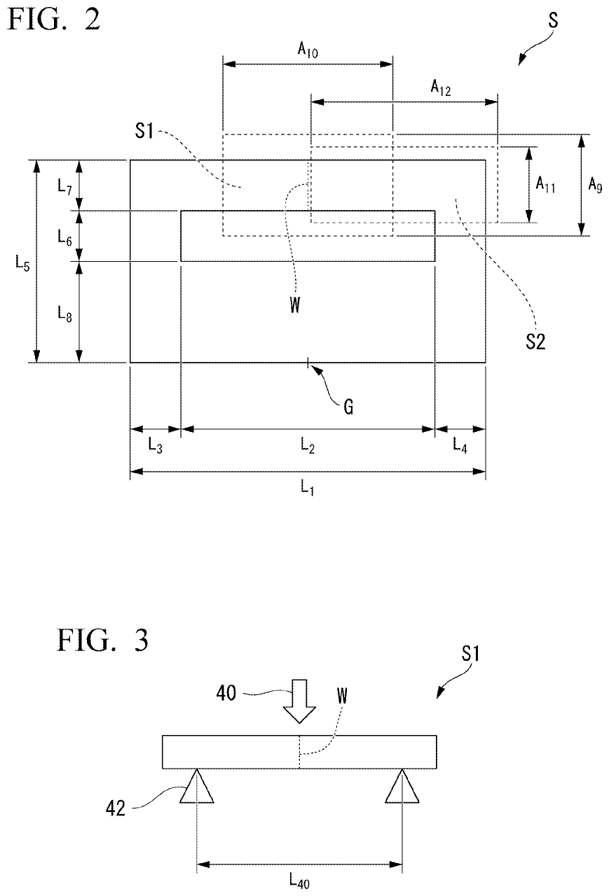

FIG. 2 shows a top view of a test piece S used in the weld bending strength test. The test piece S is a molded article obtained by molding a pellet-shaped liquid crystal polyester resin composition using an injection molding machine (“ROBOSHOTS-2000i 30B” manufactured by FANUC Corporation).

Test Piece S

Dimensions of the test piece S were L₁:35 mm, L₃, L₄: 5 mm, L₂:25 mm, L₅:20 mm, L₆, L₇: 5 mm, and L₈:10 mm. There is no resin composition in a portion of L₂×L₆. The thickness of the test piece S in the range shown in L₇ is 0.3 mm. The thickness thereof in the range shown in L₈ is 0.5 mm. The range shown in L₆ is inclined.

The test piece S was formed by injecting the resin composition from the position indicated by reference numeral G. The test piece S had a weld line formed at a position indicated by reference numeral W.

From the test piece S, a test piece S1 used for the bending strength test of the welded portion and a test piece S2 used for the bending strength test of the non-welded portion were cut out. The cut-out portion is a portion surrounded by the dotted line in FIG. 2.

Test Piece S1

In the preparation of the test piece S1, the cutting position was adjusted so that the weld line was located at the center of the test piece S1 in the long axis direction. A shape of the test piece S1 was rectangular.

A cutting range was A₁₀×A₉. The length of the minor axis of the test piece S1 was 5 mm, which was substantially the same as L₇, and the length of the major axis was 15 mm.

Test Piece S2

In the preparation of the test piece S2, when the test piece S2 was placed on a support base 42 instead of the test piece S1 shown in FIG. 3, the cutting position was adjusted so that the weld line was not included between L₄₀. A shape of the test piece S2 was rectangular.

A cutting range was A₁₂×A₁₁. The length of the minor axis of the test piece S2 was 5 mm, which was substantially the same as L₇, and the length of the major axis was 15 mm.

Bending Strength Test

A test method of the bending strength test will be described with reference to FIG. 3. The test piece S1 was placed on the support base 42 having a fulcrum-to-fulcrum distance L⁴⁰ of 5 mm using the following device used, and an indenter was moved in the direction indicated by reference numeral 40 at a test speed of 2 mm/min to carry out the weld bending strength test by a three-point bending test. The indenter has a tip radius R=0.5 mm, and the test piece S1 was arranged so that the indenter and the welded portion overlap each other so that a load was applied to the welded portion at the time of measurement. As for the bending strength test of the non-welded portion, a three-point bending test was performed on the test piece S2 under the same conditions as described above.

(Device Used)

Precision load measuring instrument MODEL-1605 II VL, manufactured by Aiko Engineering Co., Ltd.

A retention rate of the bending strength of the non-welded portion with respect to the bending strength of the welded portion was calculated. For example, in Example 1, a retention rate was calculated as follows.

Retention rate (%)=50/155×100=32%

The same calculation was performed for the subsequent examples and comparative examples.

<Method for Measuring Number Average Fiber Length of all Fibrous Filling Materials>

5 g of the liquid crystal polyester resin composition pellets were heated in a muffle furnace (manufactured by Yamato Scientific Co., Ltd., “FP410”) at 600° C. for 4 hours in an air atmosphere to remove a resin to obtain an ashing residue containing a fibrous filling material. 0.3 g of the ashing residue was added to 50 mL of pure water, and 0.5% by volume micro-90 (manufactured by Sigma-Aldrich Japan GK) aqueous solution was added as a surfactant to obtain a liquid mixture. The obtained liquid mixture was ultrasonically dispersed for 5 minutes to prepare a sample solution in which the fibrous filler contained in the ashing residue was uniformly dispersed in a solution. For ultrasonic dispersion, device name: ULTRA SONIC CLEANER NS200-60 (manufactured by Nissei Tokyo Office Co., Ltd.) was used. The ultrasonic intensity was 30 kHz.

Next, the obtained sample solution was placed in a 5 mL sample cup with a pipette and diluted 5-fold with pure water to obtain a sample liquid. Using a particle shape image analyzer (“PTTA-3” manufactured by Seishin Enterprise Co., Ltd.) under the following conditions, the obtained sample liquid was passed through a flow cell, and fibrous filling materials that move in the liquid were imaged one by one. The time when the number of all fibrous filling materials accumulated from the start of measurement reaches 30000 was defined as the end of measurement.

[Conditions]

Number of measurements: 30000

Dispersion solvent: Water

Dispersion conditions: 0.5% by volume aqueous solution of micro-90 is used as a carrier liquid 1 and a carrier liquid 2.

Sample liquid speed: 4.17 μL/sec

Carrier liquid 1 speed: 500 μL/sec

Carrier liquid 2 speed: 500.33 μL/sec

Observation magnification: Objective 10 times

Dimming filter: Diffusion PL

An obtained image was binarized, the circumscribing rectangular major axes of a fibrous filling material component in the processed image were measured, and an average value of values of 30000 circumscribing rectangular major axes was calculated as the number average fiber length of all fibrous filling material components.

TABLE 1

| | | Unit | Example 1 | Example 2 | Example 3 | Example 4 |
|---|---|---|---|---|---|---|
| Component (A) | | Part(s) | 100 | 100 | 100 | 100 |
| | | by mass | | | | |
| Component (B) | | Part(s) | 90 | 80 | 60 | 50 |
| | | by mass | | | | |
| Component (C) | | Part(s) | 10 | 20 | 40 | 17 |
| | | by mass | | | | |
| Melt | Condi- | Pa · s | 54 | 65 | 41 | 45 |
| viscosity | tion (1) | | | | | |
| (350° C.) | Condi- | Pa · s | 9.1 | 7.3 | 2.4 | 8.3 |
| | tion (2) | | | | | |

| | | | | | |
|---|---|---|---|---|---|
| (1)/(2) | — | 5.9 | 8.9 | 17 | 5.4 |
| Flow start temperature | ° C. | 325 | 326 | 327 | 323 |
| Number average fiber | μm | 77 | 73 | 55 | 75 |
| length of all fibrous | | | | | |
| filling materials | | | | | |
| Weld bending strength | MPa | 50 | 55 | 50 | 51 |
| Non-weld bending strength | MPa | 155 | 157 | 148 | 145 |
| Retention rate | % | 32 | 35 | 34 | 35 |

TABLE 2

| | | | Comparative | Comparative | Comparative | Comparative | Comparative |
|---|---|---|---|---|---|---|---|
| | | Unit | Example 1 | Example 2 | Example 3 | Example 4 | Example 5 |
| Component (A) | | Part(s) | 100 | 100 | 100 | 100 | 100 |
| | | by mass | | | | | |
| Component (B) | | Part(s) | 33 | 43 | 54 | 67 | 82 |
| | | by mass | | | | | |
| Component (C) | | Part(s) | — | — | — | — | — |
| | | by mass | | | | | |
| Melt | Condi- | Pa · s | 35 | 39 | 41 | 55 | 62 |
| viscosity | tion (1) | | | | | | |
| (350° C.) | Condi- | Pa · s | 14 | 15 | 16 | 17 | 18 |
| | tion (2) | | | | | | |
| (1)/(2) | | — | 2.5 | 2.6 | 2.6 | 3.2 | 3.4 |
| Flow start temperature | | ° C. | 323 | 323 | 324 | 328 | 328 |
| Number average fiber | | μm | 99 | 92 | 88 | 84 | 80 |
| length of all fibrous | | | | | | | |
| filling materials | | | | | | | |
| Weld bending strength | | MPa | 24 | 33 | 33 | 35 | 37 |
| Non-weld bending strength | | MPa | 131 | 145 | 150 | 155 | 153 |
| Retention rate | | % | 18 | 23 | 22 | 23 | 24 |
| | | | Comparative | Comparative | Comparative | Comparative | Comparative |
| | | Unit | Example 6 | Example 7 | Example 8 | Example 9 | Example 10 |
| Component (A) | | Part(s) | 100 | 100 | 100 | 100 | 100 |
| | | by mass | | | | | |
| Component (B) | | Part(s) | 100 | — | — | — | — |
| | | by mass | | | | | |
| Component (C) | | Part(s) | — | 5.0 | 11 | 18 | 25 |
| | | by mass | | | | | |
| Melt | Condi- | Pa · s | 83 | 5.8 | 6.6 | 9.4 | 12 |
| viscosity | tion (1) | | | | | | |
| (350° C.) | Condi- | Pa · s | 23 | 2.5 | 2.7 | 3.1 | 3.1 |
| | tion (2) | | | | | | |

| | | | | | | |
|---|---|---|---|---|---|---|
| (1)/(2) | — | 3.6 | 2.3 | 2.4 | 3.0 | 3.9 |
| Flow start temperature | ° C. | 330 | 320 | 320 | 321 | 321 |
| Number average fiber | μm | 66 | 26 | 22 | 20 | 19 |
| length of all fibrous | | | | | | |
| filling materials | | | | | | |
| Weld bending strength | MPa | 37 | 20 | 22 | 22 | 25 |
| Non-weld bending strength | MPa | 152 | 100 | 142 | 166 | 180 |
| Retention rate | % | 24 | 20 | 16 | 13 | 14 |

TABLE 3

| | | | Comparative | Comparative | Comparative | Comparative |
|---|---|---|---|---|---|---|
| | | Unit | Example 11 | Example 12 | Example 13 | Example 14 |
| Component (A) | | Part(s) | 100 | 100 | 100 | 100 |
| | | by mass | | | | |
| Component (B) | | Part(s) | — | — | — | — |
| | | by mass | | | | |
| Component (C) | | Part(s) | 33 | 43 | 54 | 67 |
| | | by mass | | | | |
| Melt | Condi- | Pa · s | 16 | 25 | 31 | 28 |
| viscosity | tion (1) | | | | | |
| (350° C.) | Condi- | Pa · s | 3.5 | 5.3 | 6.2 | 7.0 |
| | tion (2) | | | | | |
| (1)/(2) | | — | 4.6 | 4.7 | 5.0 | 4.0 |
| Flow start temperature | | ° C. | 322 | 322 | 324 | 326 |
| Number average fiber | | μm | 19 | 14 | 9.8 | 7.5 |
| length of all fibrous | | | | | | |
| filling materials | | | | | | |
| Weld bending strength | | MPa | 27 | 30 | 25 | 20 |
| Non-weld bending strength | | MPa | 183 | 199 | 128 | 120 |
| Retention rate | | % | 15 | 15 | 20 | 17 |
| | | | Comparative | Comparative | Comparative | Comparative |
| | | Unit | Example 15 | Example 16 | Example 17 | Example 18 |
| Component (A) | | Part(s) | 100 | 100 | 100 | 100 |
| | | by mass | | | | |
| Component (B) | | Part(s) | 20 | 13 | 99 | 100 |
| | | by mass | | | | |
| Component (C) | | Part(s) | 13 | 20 | 1.0 | 22 |
| | | by mass | | | | |
| Melt | Condi- | Pa · s | 33 | 28 | 82 | — |
| viscosity | tion (1) | | | | | |
| (350° C.) | Condi- | Pa · s | 11 | 10 | 20 | — |
| | tion (2) | | | | | |

| | | | | | |
|---|---|---|---|---|---|
| (1)/(2) | — | 3.0 | 2.8 | 4.1 | — |
| Flow start temperature | ° C. | 322 | 323 | 330 | — |
| Number average fiber | μm | 85 | 37 | 65 | — |
| length of all fibrous | | | | | |
| filling materials | | | | | |
| Weld bending strength | MPa | 27 | 25 | 25 | Could not be |
| | | | | | granulated |
| Non-weld bending strength | MPa | 145 | 150 | 152 | — |
| Retention rate | % | 19 | 17 | 16 | — |

As shown in Table 1 above, in Examples 1 to 4 to which the present invention was applied, it was confirmed that the retention rate of the non-weld bending strength with respect to the weld bending strength was 30% or higher, and the weld strength was high even in a case where an ultra-thin molded article was produced. On the other hand, in Comparative Examples 1 to 18 to which the present invention was not applied, all retention rates were 25% or lower.

TABLE 4

| | | | | | | Comparative | Comparative | Comparative |
|---|---|---|---|---|---|---|---|---|
| | | Unit | Example 5 | Example 6 | Example 7 | Example 19 | Example 20 | Example 21 |
| Component (A) | | Part(s) | 100 | 100 | 100 | 100 | 100 | 100 |
| | | by mass | | | | | | |
| Component (B) | | Part(s) | 80 | 80 | 80 | | | |
| | | by mass | | | | | | |
| Component (C) | (C)-1 | Part(s) | 20 | | | 40 | | |
| | | by mass | | | | | | |
| | (C)-2 | Part(s) | | 20 | | | 40 | |
| | | by mass | | | | | | |
| | (C)-3 | Part(s) | | | 20 | | | 40 |
| | | by mass | | | | | | |
| Melt | Condi- | Pa · s | 44 | 51 | 51 | 35 | 32 | 21 |
| viscosity | tion (1) | | | | | | | |
| (350° C.) | Condi- | Pa · s | 8.2 | 9.4 | 7.7 | 8.5 | 8.2 | 7.2 |
| | tion (2) | | | | | | | |

| | | | | | | | |
|---|---|---|---|---|---|---|---|
| (1)/(2) | — | 5.4 | 5.4 | 6.6 | 4.1 | 3.9 | 2.9 |
| Flow start temperature | ° C. | 325 | 320 | 323 | 325 | 323 | 322 |
| Number average fiber | μm | 61 | 44 | 51 | 33 | 42 | 31 |
| length of all fibrous | | | | | | | |
| filling materials | | | | | | | |
| Weld bending strength | MPa | 51 | 41 | 43 | 29 | 21 | 24 |
| Non-weld bending strength | MPa | 161 | 137 | 151 | 161 | 160 | 166 |
| Retention rate | % | 32 | 30 | 28 | 18 | 13 | 14 |

As shown in Table 4 above, in Examples 5 to 7 to which the present invention was applied, it was confirmed that the retention rate of the non-weld bending strength with respect to the weld bending strength was higher than that of Comparative Examples 19-21, and the weld strength was high even in a case where an ultra-thin molded article was produced.

1. A liquid crystal polyester resin composition comprising, as essential components:
a component (A): liquid crystal polyester;
a component (B): a glass fiber; and
a component (C): a fibrous inorganic filling material different from the component (B),
wherein a blending amount of the component (B) with respect to 100 parts by mass of the component (A) is 50 parts by mass or more and 90 parts by mass or less,
a blending amount of the component (C) with respect to 100 parts by mass of the component (A) is 1 part by mass or more and 40 parts by mass or less, and
the following conditions (1) and (2) are satisfied.
Condition (1): melt viscosity measured at a predetermined measurement temperature within a temperature range of 20° C. to 30° C. higher than a flow start temperature range according to ISO 11443 under a condition of a shear rate of 1000 s⁻¹ is 40 Pa·s or higher and 70 Pa·s or lower
Condition (2): melt viscosity measured at the measurement temperature according to ISO 11443 under a condition of a shear rate of 12000 s⁻¹ is 0.1 Pa·s or higher and 10 Pa·s or lower

2. The liquid crystal polyester resin composition according to claim 1,
wherein a ratio ((1)/(2)) of the melt viscosity measured under the condition (1) to the melt viscosity measured under the condition (2) exceeds 5.0.

3. The liquid crystal polyester resin composition according to claim 1,
wherein a number average fiber length of all fibrous filling materials in which the component (B) and the component (C) are combined is 40 μm or more and 80 μm or less.

4. The liquid crystal polyester resin composition according to claim 1,
wherein the flow start temperature is 320° C. or higher and 330° C. or lower, and
the measurement temperature is 350° C.

5. The liquid crystal polyester resin composition according to claim 1,
wherein the component (C) is wollastonite.

6. A molded article using the liquid crystal polyester resin composition according to claim 1 as a forming material.

7. The liquid crystal polyester resin composition according to claim 2,
wherein a number average fiber length of all fibrous filling materials in which the component (B) and the component (C) are combined is 40 m or more and 80 m or less.

8. The liquid crystal polyester resin composition according to claim 2,
wherein the flow start temperature is 320° C. or higher and 330° C. or lower, and
the measurement temperature is 350° C.

9. The liquid crystal polyester resin composition according to claim 2,
wherein the component (C) is wollastonite.

10. A molded article using the liquid crystal polyester resin composition according to claim 2 as a forming material.
